(19) United States
(12) Patent Application Publication
(10) Pub. No.: US 2011/0142980 A1
(43) Pub. Date: Jun. 16, 2011

(54) DRIVE DEVICE FOR DRIVING A CLOSING PLATE IN A VERTICAL MOULD CASTING MACHINE AND MACHINE COMPRISING SAID DEVICE

(75) Inventors: Shanti Gafarsoro Urrestilla, Vitoria Gazteiz (ES); Francisco Javier Calvo Poza, Vitoria-Gazteiz (ES); Eneko Sanchez Jimenez, Aretxabaleta (Guipuzcoa) (ES); Mikel Bikandi Bikandi, Aretxabaleta (Guipuzcoa) (ES)

(73) Assignee: LORAMENDI, S.COOP., Vitoria-Gasteiz (ES)

(21) Appl. No.: 13/057,655

(22) PCT Filed: Aug. 7, 2008
(86) PCT No.: PCT/ES08/00551

§ 371 Date: Feb. 4, 2011

(51) Int. Cl. B28B 13/06

(52) U.S. Cl. 425/443

(57) ABSTRACT

The invention relates to a drive device for driving a closing plate in a vertical mould casting machine, the mentioned machine comprising displacement means for displacing the closing plate for compacting the casting and for extracting it from the machine. The displacement means comprise electric drive means and transmission means which are arranged between the mentioned electric drive means and the closing plate. The transmission means and the electric drive means are configured to transmit to the closing plate a first displacement with a first speed and a second displacement with a second speed greater than the first.

### TECHNICAL FIELD OF THE INVENTION

The invention is comprised in the field of vertical mould casting machines, and it has been improved to achieve a production increase as a result of a work cycle time reduction, as well as better compacting of the casting.

### BACKGROUND OF THE INVENTION

Vertical sand mould casting machines comprise a generally rectangular moulding chamber in which the sand is blown through a hopper or bell arranged at the top. Said chamber is closed by means of two closing plates, closed at one end by a front, moving and swinging plate which allows the exit of the moulded casting, while the other end is closed by a rear plate associated to a compacting piston, which is also used to push on the casting and expel it in order to place said casting on the stack of previously produced castings.

The casting is obtained by blowing sand in the chamber, followed by compacting the sand by means of the opposing pushing of the front and rear plates. After this the front plate is opened and swiveled to allow the casting to exit, which is achieved by pushing with the rear plate, extracting the casting from the moulding chamber and placing it against the previously obtained stack of castings.

These types of are described in U.S. Pat. No. 7,007,738 and U.S. Pat. No. 6,092,585. These patents describe vertical mould casting machines comprising a moulding chamber that is closed by a front, displaceable and swinging plate and a rear plate provided at an end of an extraction piston, compacting that of the casting by opposing pressure of both plates. Castings are thus cyclically obtained forming two half-molds and, with the aid of the extraction piston, they are expelled from the moulding chamber such that they are placed against and aligned with one another, forming a stack which will travel along the corresponding work stations.

However, patent EP 1 219 830, describes vertical mould casting machine in which once the sand has been blown into the moulding chamber, the compacting is performed by the front and rear plates due to the opposing drive of two hydraulic cylinders, which push the front and rear plates to form the casting in the moulding chamber.

In the aforementioned Patent EP 1 219 830, the opening, closing and compacting movements are achieved by means of two hydraulic cylinders acting in opposition. The drive of one of the cylinders, in a first direction, displaces the rear plate for compacting and extracting the casting. The other cylinder is operated in a direction opposite to the first cylinder, acting on a rear frame which, through a series of bars, is attached to the front plate, displacing the front plate for compacting and swiveling.

Once the sand is blown into the moulding chamber, the casting is pressed by means of the opposing and simultaneous drive of the cylinder pushing the rear plate and of the cylinder pushing the front plate, thus forming the casting in the moulding chamber.

Then the cylinder of the front plate reverses its operation, causing the longitudinal and outwards displacement of the frame and therefore of the front plate. The cylinder of the rear plate continues its movement aiding the extraction of the casting. After this moment if the displacement continues a cam will swivel upwards pushing on a rod and therefore pushing and swiveling the front plate. This swiveling motion continues until the front plate is in a horizontal position at the top, in which position the casting may be extracted by the pushing action of the rear plate, which plate is driven and displaced longitudinally by the cylinder of the rear plate.

Vertical mould casting machines are also known in which so-called “plunder cylinders”, made up of two cylinders coaxially arranged and displaceable with regard to one another, such that in order to compact the casting both cylinders act simultaneously, whereas to extract the casting one of the cylinders is displaced with regard to the other.

By using hydraulic cylinders as driving devices of the closing plates, good compacting of the casting is obtained, however there are many other drawbacks derived from the use of hydraulic cylinders, such as for example, high maintenance cost, need for large surfaces to place the cylinders, which considerably increases the size of the machine, low pressure in the movements of the cylinders, greater power consumption, etc.

It is therefore advisable to provide a system for driving the closing plates that overcomes all the aforementioned drawbacks without reducing the compacting force.

### DESCRIPTION OF THE INVENTION

The object of the present invention is to achieve the displacement of a (front or rear) closing plate and, therefore quicker compacting of the casting, while at the same time seeking quicker swiveling of the front plate and extraction of the casting than what is achieved with purely hydraulic systems.

The invention relates to a drive device for driving a closing plate in a vertical mould casting machine, the mentioned machine comprising displacement means for displacing the closing plate to compact casting and for extracting it from the moulding machine. The displacement means for displacing the closing plate comprise:
electric drive means,
transmission means arranged between the electric drive means and the closing plate, the transmission means and the electric drive means being configured to transmit to the closing plate a first displacement with a first speed and a second displacement with a second speed greater than the first and, in that the second displacement is a linear displacement in a direction parallel to the first displacement.

The first speed is a slow speed with which a controlled compacting is sought by slowly displacing either the rear plate or the front plate towards the moulding chamber, very precise movements and a large compacting force thus being obtained.

The second speed is a quick speed with which a quick movement for swiveling or extracting the casting, depending on the plate on which the device object of the invention is acting, is sought. In other words, the second displacement with the second speed is intended to quickly swivel the front plate or quickly push the rear plate and thereby quickly extract the casting.

The drive device can be a simple drive device or a mixed drive device. In a simple drive device, the drive means can be at least one motor, whereas the transmission means can be chosen from different options, such as at least one screw-nut or at least one rack-pinion. The need to use one or more motors will depend on the power required by the system. In the same way, the use of one or more nuts-screws or one or more pinions-racks will depend on the needs of each system.

This drive device can be used to drive a rear plate, a front plate or to actuate the two plates. If the drive device is going to be applied to both plates, the plates can have the same transmission means or they can be different. For example, each of the plates can be driven by screw-nut transmission means or by rack-pinion transmission means, or the front plate can be driven by screw-nut transmission means and the rear plate by rack-pinion transmission means, or vice versa.

In the event that the device drives a front plate, the first displacement is configured to compact the casting, i.e., to displace the front plate towards the moulding chamber and the second displacement is configured to swivel the mentioned front plate and aid in extracting the casting. The first and second displacements are in opposite directions.

If the device drives a rear plate, the first displacement is configured to compact the casting, i.e., displace the rear plate towards the moulding chamber and the second displacement is configured to extract the mentioned casting, i.e., to push the casting to the stack of previously obtained castings. In this case, the first and second displacements are in the same direction.

As previously mentioned, the drive device can be mixed and, therefore, the transmission means can comprise first transmission means to transmit the first displacement and second transmission means to transmit the second displacement. As previously indicated, the first displacement is carried out with a first speed, slow speed, and the second displacement is carried out with a second speed, quick speed.

In the same way as in the simple drive, the slow speed serves to transmit power to the closing plate to carry out good compacting and the quick speed allows swiveling the closing plate if the device acts on a front plate, or extracting the casting if the device acts on a rear plate.

The drive means can in turn comprise first drive means for driving the first transmission means and second drive means for driving the second transmission means.

The first and second transmission means can be arranged coaxially. Specifically, the second transmission means can be linked to a first end of the closing plate and the first transmission means can be arranged between a fixed part, which is fixed to the frame of the vertical mould casting machine, and to a second end of the second transmission means. Therefore when the first transmission means are driven, the first displacement with the first speed occurs, i.e., the first transmission means pushing the second transmission means are displaced, causing the closing plate to move towards the moulding chamber, compacting the casting. The second transmission means cause the second displacement of the closing plate with the second speed, i.e., they cause the quick swiveling of the closing plate or the quick displacement of the plate to extract the casting.

The second transmission means can be joined directly to a first end of the closing plate to cause the second displacement. They can also incorporate a frame joined to a first end of the closing plate, such that the movement of the second transmission means displaces the frame, which in turn pushes the closing plate.

The first and second transmission means can be selected from at least one rack-pinion, at least one screw-nut, at least one connecting rod-crank and at least one hydraulic cylinder, whereas the first and second drive means can comprise at least one electric motor.

In a preferred embodiment the first transmission means are a screw-nut and the second transmission means are a rack-pinion. The following options are possible in alternative solutions:

| First means | Second means |
|---|---|
| Screw-nut | Screw-nut |
| Rack-pinion | Screw-nut |
| Rack-pinion | Rack-pinion |
| Hydraulic cylinder | Screw-nut |
| Hydraulic cylinder | Rack-pinion |
| Connecting rod-crank | Screw-nut |
| Connecting rod-crank | Rack-pinion |

With each of these combinations a drive device is obtained in which the compacting speed and force are optimal.

As previously indicated, the device object of the invention can be used to drive a front plate or a rear plate or both plates.

If the device serves to drive a front plate, the first displacement is configured to compact the casting and the second displacement is configured to swivel the front plate and aid in extracting the casting. In the event that the device uses a screw-nut and rack-pinion drive, the casting is compacted by means of the screw-nut, since the screw provides the necessary force to compact the casting and the front plate is swiveled by means of the rack-pinion which provides high speed.

In the event that the device drives a rear plate, the first displacement is configured to compact the casting, i.e., displace the plate towards the moulding chamber, and the second displacement is configured to quickly extract the casting, i.e., displace and position the casting in the stack of previously obtained castings. If a screw-nut and rack-pinion drive is used, the compacting is carried out by means of the screw-nut and the extraction by means of the rack-pinion.

The drive means can comprise a support, which can serve to support the electric motor.

The first and second transmission means can comprise a frame, which in turn can comprise a support for the drive means.

Also object of the invention is a vertical mould casting machine comprising the previously described drive device.

With the invention a vertical mould casting machine is obtained which presents a series of advantages such as better control of the movements of the plates, smaller size, less power consumption and lower maintenance.

### DESCRIPTION OF THE DRAWINGS

To complete the description being made and for the purpose of aiding to better understand the features of the invention according to a preferred embodiment thereof, a set of drawings is attached as an integral part of said description in which the following is shown with an illustrative and non-limiting character:

FIG. 1 shows the device object of the invention in which a simple rack-pinion type drive has been used.

FIG. 2 shows the operating sequence of the device of FIG. 1 in which the rear plate has been depicted.

FIG. 3 shows the device object of the invention using a simple screw-nut type drive.

FIG. 4 shows the operating sequence of the device of FIG. 3, in which the rear plate has been depicted.

FIG. 5 shows the device object of the invention using a mixed screw-nut and rack-pinion type drive.

FIG. 6 shows the operating sequence of the device of FIG. 5 in which the rear plate has been depicted.

FIG. 7 shows the device object of the invention using a mixed connecting rod-crank and screw-nut type drive.

FIG. 8 shows the operating sequence of the device of FIG. 7 in which the rear plate has been depicted.

FIG. 9 shows the device object of the invention using a mixed hydraulic cylinder and screw-nut type drive.

FIG. 10 shows the operating sequence of the device of FIG. 9 in which the rear plate has been depicted.

FIG. 11 shows the device object of the invention using a mixed hydraulic cylinder and rack-pinion type drive.

FIG. 12 shows the operating sequence of the device of FIG. 11 in which the rear plate has been depicted.

### PREFERRED EMBODIMENT OF THE INVENTION

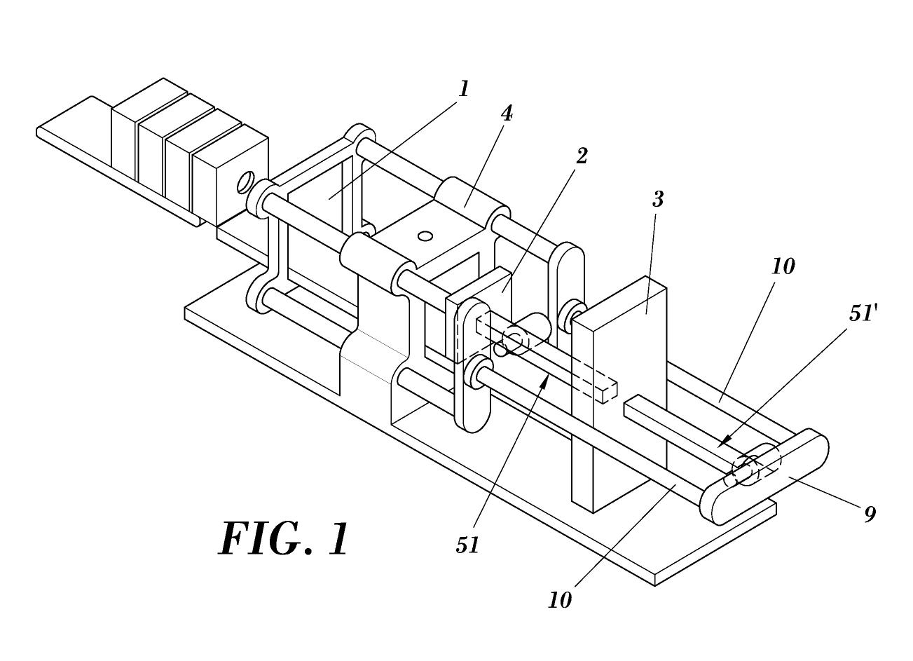

FIG. 1 shows a vertical mould casting machine using a drive device comprising a rack-pinion (51,51′). The rack-pinion (51′) acting on a front plate (1) is joined by a first end to a fixed part (3), which is fixed to the frame of the moulding machine, and the rack-pinion (51) acting on a rear plate (2) is joined in an opposing manner to the mentioned fixed part (3), such that the movement of the rack-pinion (51′) and the movement of the rack-pinion (51) are in opposite directions. The pinion rack (51) thus displaces the rear plate (2) towards the moulding chamber (4) in one direction and with a slow speed, and the rack-pinion (51′) pushes a displaceable frame (9) joined to the front plate (1) by a series of bars (10), displacing the front plate (1) towards the chamber (4) in an opposite direction and with an also slow speed. In this situation the two plates close the moulding chamber (4), compacting the casting. After compacting, the rear plate (2) continues to be displaced but at a higher speed than the first, whereas the front plate (1) is quickly retracted and swiveled, allowing the extraction of the casting. In the process of compacting of the casting, the movements of the rack-pinion (51) and the pinion rack (51′) are in opposite directions, whereas during the extraction of the casting, the movements of the rack-pinion (51 and 51′) are in the same direction. To perform a new compacting phase, the transmission means go back to their initial position, performing a reverse movement from that described for compacting the casting.

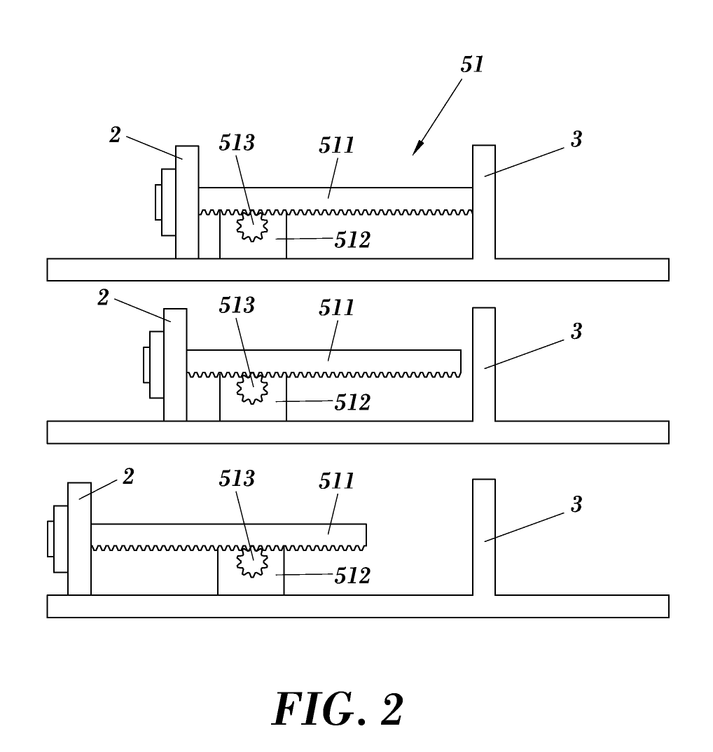

FIG. 2 shows the operating sequence with transmission means comprising a rack-pinion (51) for displacing the rear plate (2). The motor of the rack, not depicted in the figure, is arranged in a support (512) and displaces the rack (511) through the pinion (513) by means of a slow movement with which the rear plate (2) is displaced towards the chamber (4), and therefore the casting is compacted. Then the motor, with a second speed quicker than the first, displaces the plate (2) and thereby extracts and places the casting in the stack of previously obtained castings. Both the slow speed and quick speed are provided by the mentioned motor either directly or by means of a gear.

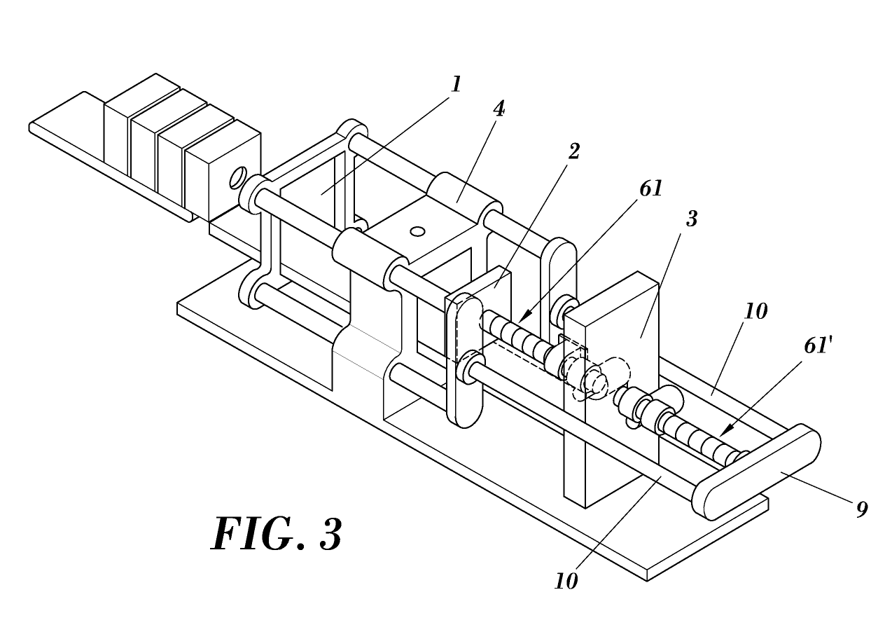

FIG. 3 shows a vertical mould casting machine with screw-nut transmission means (61) acting on the rear plate (2) and screw-nut transmission means (61′), acting on a front plate (1). As in the previous case, the screw-nut (61) drive of the rear plate (2) and the screw-nut (61′) drive of the front plate are joined in an opposite manner to the fixed part (3). The screw-nut (61) thus displaces the rear plate (2) towards the moulding chamber (4) in one direction and with a slow speed and the screw-nut (61′) displaces the front plate (1) towards the chamber (4) in an opposite direction and with an also slow speed, thus compacting the casting. After compacting, the rear plate (2) continues to be displaced but at a much higher speed than the first, whereas the front plate (1) is quickly retracted and swiveled, allowing the extraction of the casting.

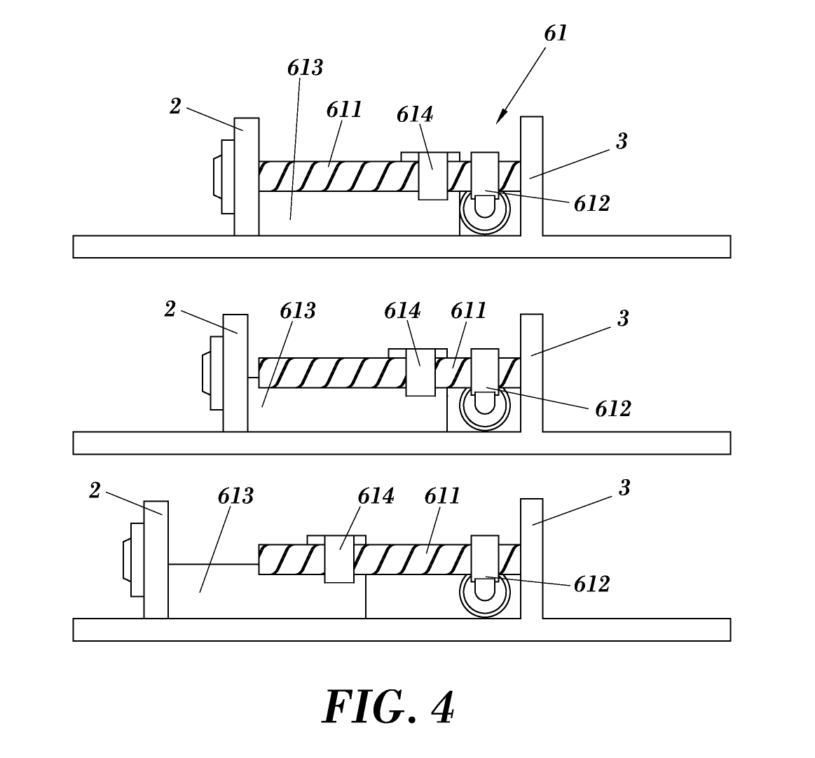

In the operating sequence of the rear plate (2) depicted in FIG. 4, it can be seen how the motor of the screw, not depicted in the figures, rotates the screw (611) through a crown (612). In this case the transmission means (61) comprise a frame (613), comprising the nut (614) which is moved by the screw (611) and the rear part of the rear plate (2), such that when the screw (611) rotates, the mentioned frame (613) is longitudinally displaced, pushing the rear plate (2) towards the moulding chamber (4) and thus compacting the casting. Then the motor provides a quick movement and the frame (613) is displaced, driven by the screw (611), pushing the rear plate (2), and therefore the already compacted casting, towards the stack of castings.

As previously mentioned, the front (1) and rear (2) plates could also be driven by different transmission means, i.e., the front plate could be driven by a screw-nut and the rear plate (2) could be driven by a rack-pinion and vice versa.

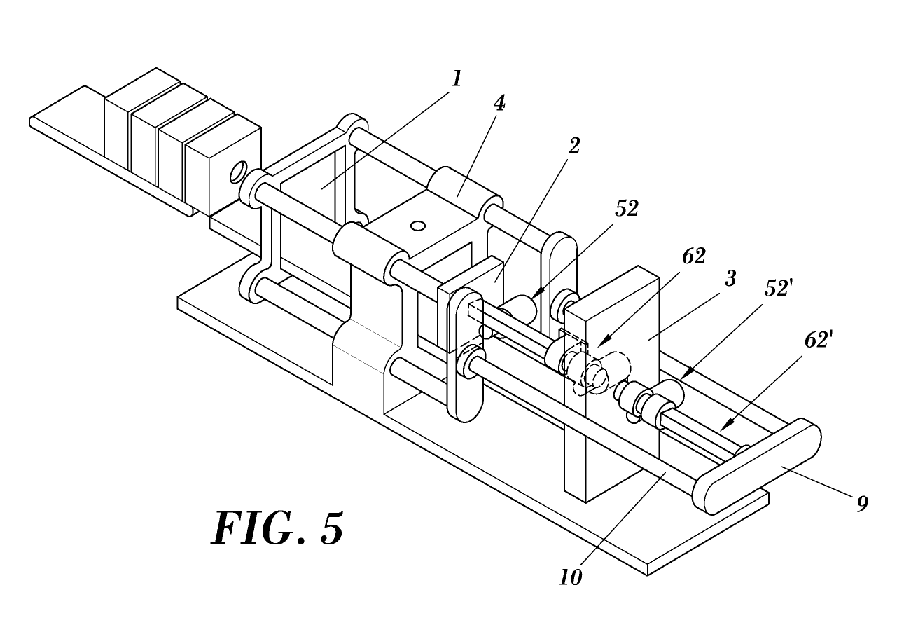

FIG. 5 shows a mixed drive, i.e., made up of first transmission means and second transmission means, for example, the first means can be a screw-nut (62,62′) and the second means a rack-pinion (52,52′). The first transmission means, i.e., the screw-nut (62,62′), cause the first displacement with slow speed and the second transmission means, i.e., the rack-pinion (52,52′), cause the second displacement with quick speed. As occurred in the simple drive, the transmission means acting on the rear plate (2) are arranged in a manner opposite to the transmission means acting on the front plate (1). The screw-nut (62) is thus joined to the fixed part (3) and the screw-nut (62′) is joined in the opposite manner to the mentioned fixed part (3). Then the rack-pinion (52,52′) is arranged coaxially to the screw-nut (62,62′).

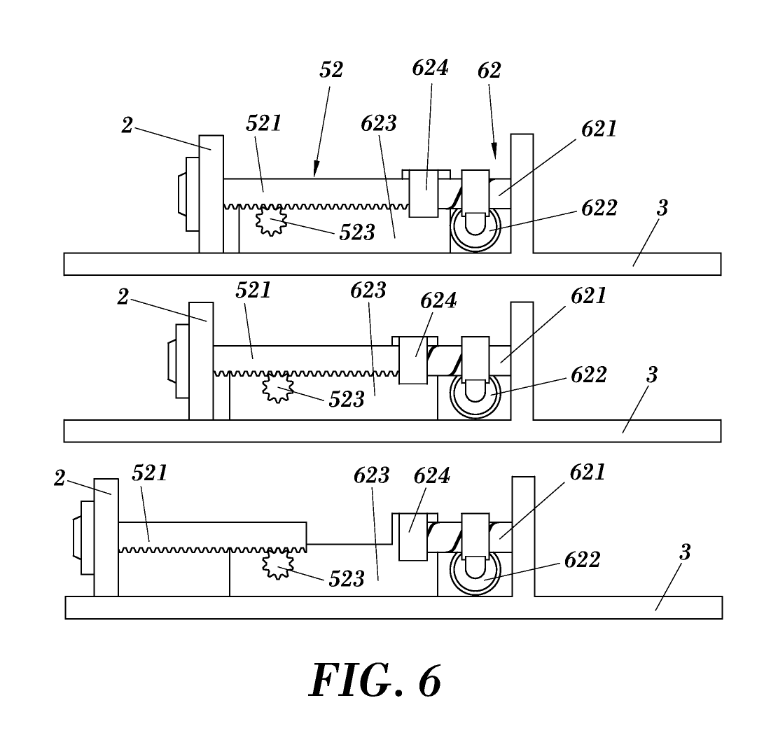

FIG. 6 shows the operating sequence of the rear plate (2). The motor of the screw, not depicted in the figures, rotates the screw (621) through the crown (622), transmitting slow movement to the rack-pinion (52) through the nut (624) comprised by the frame (623). With this slow movement, the rear plate (2) is pushed and therefore the casting is compacted. Once it is compacted, the motor of the rack, not depicted in the figures, is actuated, transmitting movement to the rack (521) through the pinion (523), in order to quickly displace the rear plate (2), i.e., expel the casting towards the stack of castings. The motor of the rack can be mounted on the frame (623) or on an independent support, or it can be mounted on the bed plate of the machine itself.

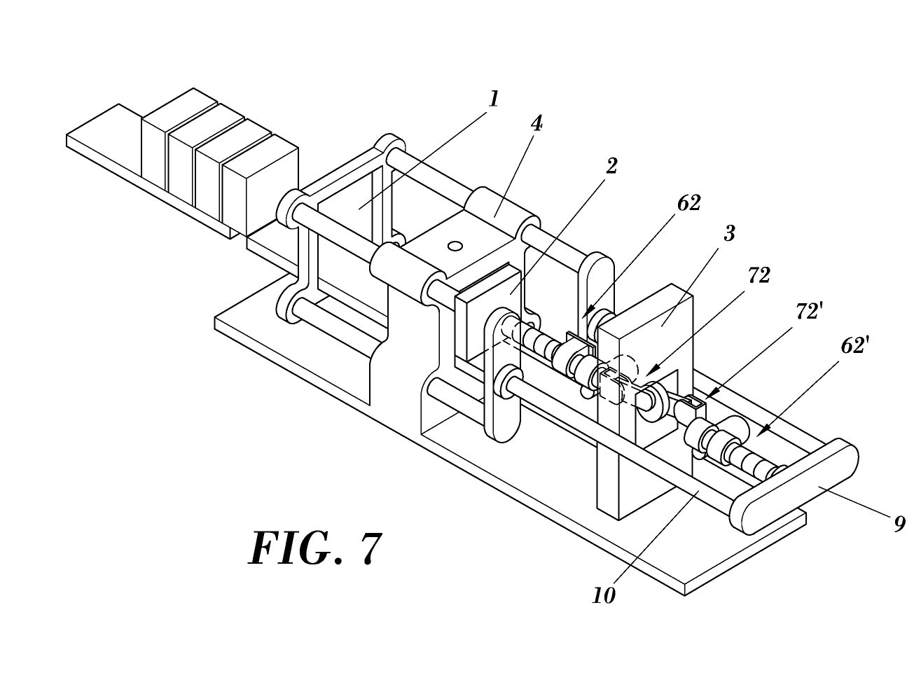

FIG. 7 depicts a mixed drive for each of the plates, in which the first transmission means comprise a connecting rod-crank (72,72′) and the second transmission means comprise a screw-nut (62,62′). The connecting rod-crank (72,72′) and the screw-nut (62,62′) of each of the plates are arranged coaxially, such that the connecting rod-crank (72,72′) is joined to the fixed part (3) and then the screw-nut (62,62′) is arranged, which has coupled thereto a frame (623) that is joined to the rear plate (2) and a frame (623′) that is joined to the front plate (1). The first and second transmission means associated to the rear plate (2) act in a manner opposite to the first and second transmission means of the front plate (1).

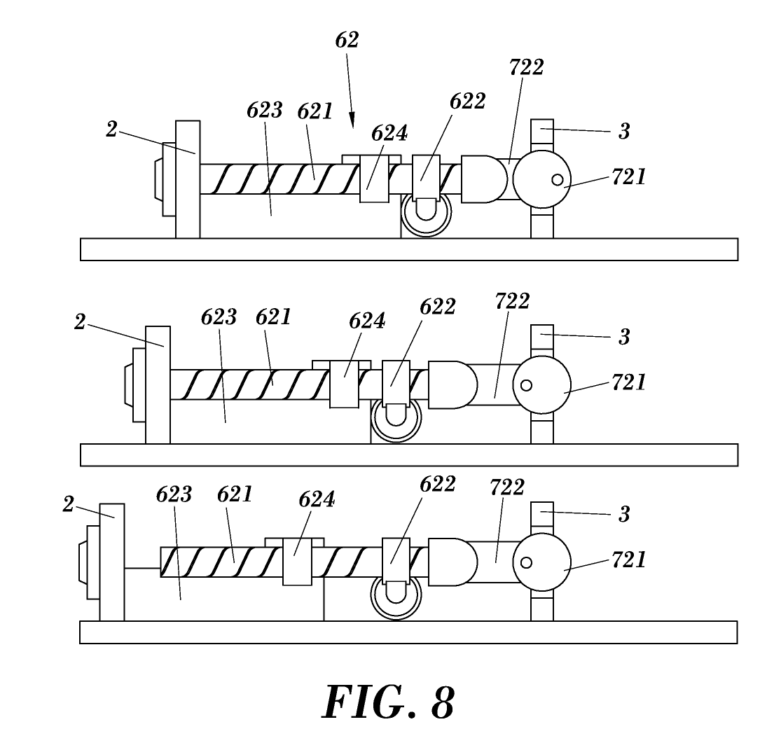

FIG. 8 shows the operation of this type of mixed drive. By means of the rotation of the crank (721) through the connecting rod (722), the screw (621) is pushed and the screw pushes the rear plate (2), thus slowly displacing the rear plate (2) and thus compacting the casting. Then the motor of the screw, not depicted in the figures, rotates the screw (621). The quick movement is transmitted through the nut (624) and the frame (623) integral thereto to the rear plate (2), thus being able to extract the casting.

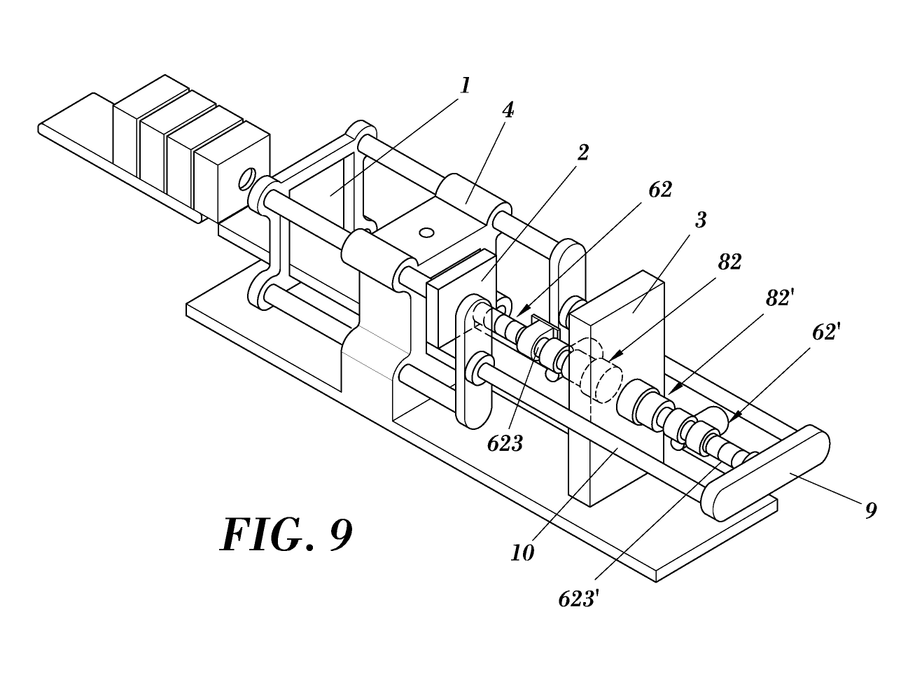

FIG. 9 shows a vertical mould casting machine using a mixed drive device for each of the plates, in which the first transmission means comprise a hydraulic cylinder (82,82′) and the second transmission means comprise a screw-nut (62,62′). These transmission means are arranged coaxially such that the hydraulic cylinder (82,82′) is joined to the fixed part (3), and then the screw-nut (62,62′) is arranged, which screw-nut comprises a frame (623,623′) integral to the same, which is joined to the rear plate (2) or to the front plate (1) through the displaceable frame (9).

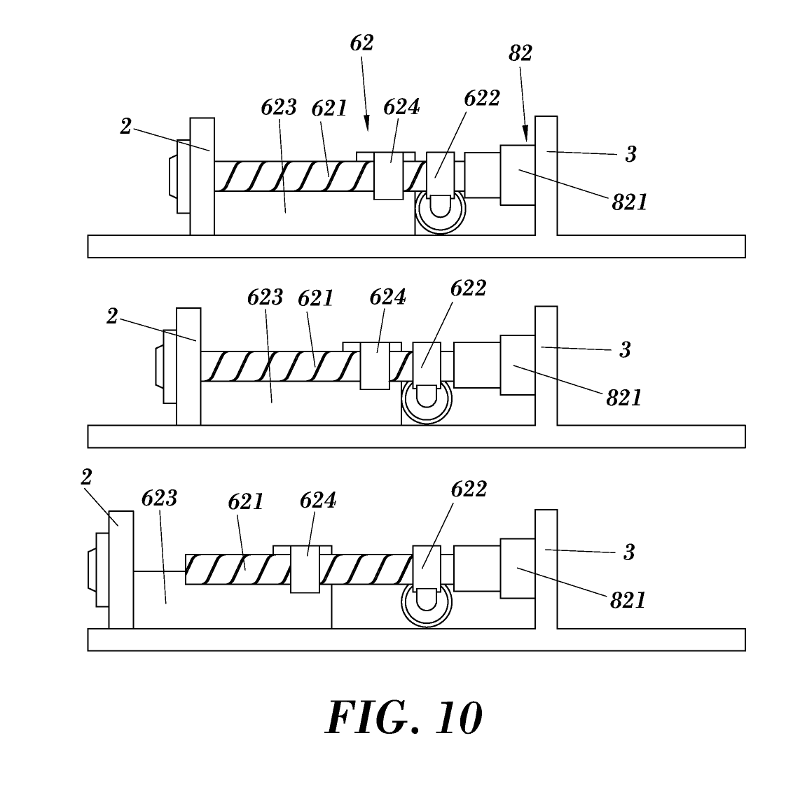

The operating sequence for a rear plate (2) is depicted in FIG. 10. The hydraulic cylinder (821) is activated, slowly displacing the screw-nut (62), which pushes the rear plate (2), compacting the casting. After compacting, the motor of the screw, not depicted in the figures, rotates the screw (621) through the crown (622), quickly displacing the frame (623) integral to the nut (624) pushing the rear plate (2) and thereby extracting the casting.

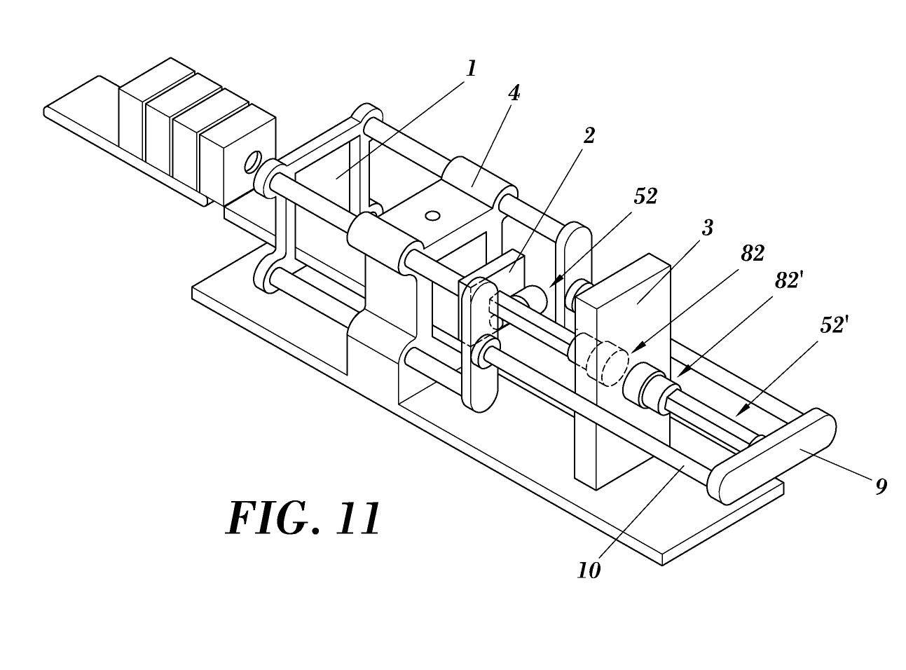

FIG. 11 depicts a mixed drive for each of the plates in which the first transmission means comprise a hydraulic cylinder (82,82′) and the second transmission means comprise a rack-pinion (52,52′). The hydraulic cylinder (82) and the rack-pinion (52) are arranged in a manner opposite to the cylinder (82′) and to the rack-pinion (52′). The hydraulic cylinder (82,82′) is joined to the fixed part (3) and the rack-pinion (52,52′) is coaxially arranged.

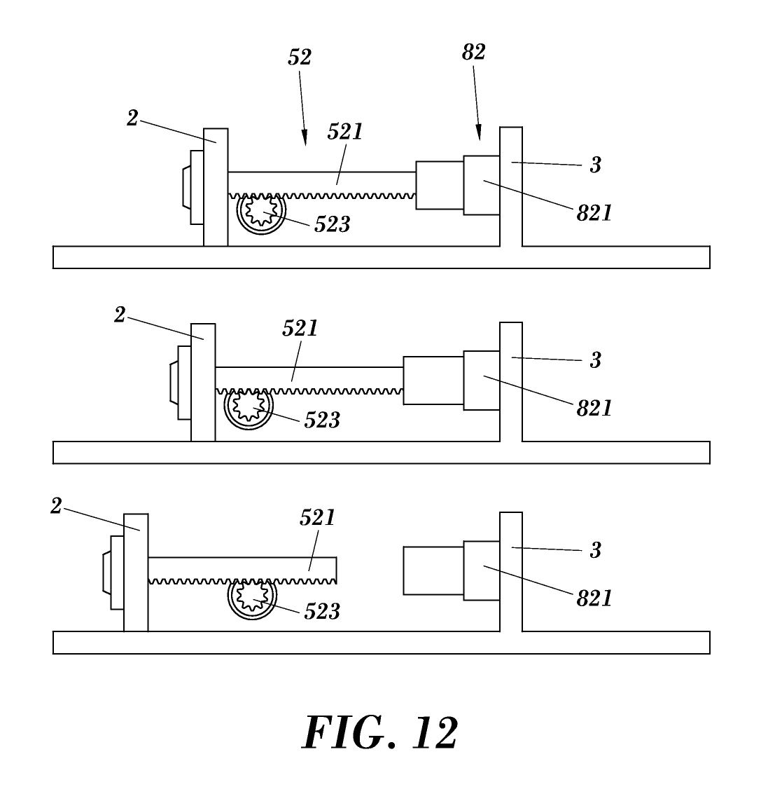

FIG. 12 depicts the operating sequence of the rear plate (2). The activation of the hydraulic cylinder (821) causes the displacement of the rack-pinion (52), and in turn of the rear plate (2) compacting the casting. The rack (521) is subsequently driven through its pinion (523) in order to quickly displace the rear plate, and thereby extract the casting. Then the rack-pinion (52) moves back to the position of contact with the hydraulic cylinder (821); after this moment the rack-pinion (52) and the hydraulic cylinder (821) simultaneously go back until the reach the initial position.

There could also be coupling means between the rack-pinion (52) and the hydraulic cylinder (821), such that the rack-pinion (52) goes back until contacting with the hydraulic cylinder (821), the coupling occurring and, after that moment, the hydraulic cylinder (821) goes back and drives the rack-pinion to the initial position.

The sequence and positioning in each of the previously described options for a front plate would be the same as that which has been described for the rear plate, the only difference being that the mentioned front plate is swiveled during the quick movement.

It is obvious that the combination of transmission means can be multiple, since the order in the arrangement of the first and second means can vary.

1-14. (canceled)

15. Drive device for driving a closing plate in a vertical mould casting machine, the mentioned machine comprising displacement means for displacing the closing plate for compacting a casting and for extracting it from the moulding machine, wherein the displacement means for displacing the closing plate comprise drive means and transmission means (51, 51′, 61, 61′, 52, 52′, 62, 62′) arranged between the drive means and the closing plate, characterized in that:
displacement means for displacing the closing plate for compacting a casting and for extracting it from the moulding machine are electric; and in that
transmission means (51, 51′, 61, 61′, 52, 52′, 62, 62′) and electric drive means are configured to transmit to the closing plate a first displacement with a first speed for compacting a casting and a second displacement with a second speed greater than the first, and in that the second displacement is a linear displacement in a direction parallel to the first displacement.

16. Drive device for driving a closing plate according to claim 15, characterized in that the drive means comprise at least one motor and the transmission means comprise at least one screw-nut (61, 61′).

17. Drive device for driving a closing plate according to claim 15, characterized in that the drive means comprise at least one motor and the transmission means comprise at least one rack-pinion (51, 51′).

18. Drive device for driving a closing plate according to claim 15, characterized in that the transmission means comprise first transmission means (52, 52′, 62, 62′) to transmit the first displacement and second transmission means (52, 52′, 62, 62′) to transmit the second displacement and in that the electric drive means comprise first drive means for driving the first transmission means (52, 52′, 62, 62′) and second drive means for driving the second transmission means (52, 52′, 62, 62′).

19. Drive device for driving a closing plate according to claim 18, characterized in that the first electric drive means and the second electric drive means comprise at least one electric motor.

20. Drive device for driving a closing plate according to claim 18, characterized in that the first transmission means are selected from rack-pinion (52, 52′), screw-nut (62, 62′).

21. Drive device for driving a closing plate according to claim 18, characterized in that the second transmission means are selected from rack-pinion (52, 52′), screw-nut (62, 62′).

22. Drive device for driving a closing plate according to claim 20, characterized in that the first and second drive means comprise a frame (623, 623′).

23. Drive device for driving a closing plate according to claim 22, characterized in that the frame (623, 623′) is configured to support the electric motor.

24. Drive device for driving a closing plate according to claim 15, characterized in that the closing plate is a front plate (1).

25. Drive device for driving a closing plate according to claim 24, characterized in that the first displacement is configured to compact the casting and the second displacement is configured to swivel the front plate (1).

26. Drive device for driving a closing plate according to claim 15, characterized in that the closing plate is a rear plate (2).

27. Drive device for driving a closing plate according to claim 26, characterized in that the first displacement is configured to compact the casting and the second displacement this configured to extract the mentioned casting.

28. Vertical mold casting machine characterized in that it comprises a device according to claim 15.
